(19) United States
(12) Patent Application Publication
(10) Pub. No.: US 2018/0342716 A1
(43) Pub. Date: Nov. 29, 2018

(54) BATTERY PACK

(71) Applicant: CONTEMPORARY AMPEREX TECHNOLOGY CO., LIMITED, Ningde (CN)

(72) Inventors: Yannan CHU, Ningde (CN); Zongxiang LUO, Ningde (CN); Wenhui ZHANG, Ningde (CN)

(21) Appl. No.: 15/980,540

(22) Filed: May 15, 2018

(30) Foreign Application Priority Data
May 25, 2017 (CN) 201710378385.9

(51) Int. Cl. H01M 2/10

(52) U.S. Cl. CPC H01M 2/1016

(57) ABSTRACT

The present disclosure provides a battery pack, which comprises a base plate and at least one battery module. Each battery module comprises: a battery group; two end plates respectively positioned at two ends of the battery group in the Y direction; and two side plates respectively positioned at two ends of the battery group in an X direction. Each battery module is fixed to the base plate, and one of the side plates of each battery module faces the base plate. The structure of the battery pack is simple and the assembling of the battery pack is convenient. Compared with the positive arrangement of the traditional battery module, the battery pack greatly improves the space utilization of the battery pack and reduces the overall size and weight of the battery pack.

### REFERENCE TO RELATED APPLICATIONS

The present application claims priority to Chinese patent application No. CN201710378385.9, filed on May 25, 2017, which is incorporated herein by reference in its entirety.

### FIELD OF THE PRESENT DISCLOSURE

The present disclosure relates to the field of battery technology, and particularly relates to a battery pack.

### BACKGROUND OF THE PRESENT DISCLOSURE

At present, the battery pack is always assembled by a way that the battery modules are provided in the positive arrangement and each of battery control units is provided above each battery module. Here, the positive arrangement is that the two end plates and the two side plates of each battery module are perpendicular to the base plate of the battery pack (namely, the height direction of each battery module is parallel to the thickness direction of the base plate). However, because the height and the width of the battery module are different (the width is about 1.4 times of the height), so in some of the battery packs (especially when the height of the battery pack is far greater than the height of the battery module but is not enough to allow the battery modules to be arranged in two layers in the positive arrangement), the positive arrangement is often not high in the space utilization and can make the circuits of the battery control units more complex.

### SUMMARY OF THE PRESENT DISCLOSURE

In view of the problem existing in the background, an object of the present disclosure is to provide a battery pack, the structure of the battery pack is simple and the assembling of the battery pack is convenient, which improves the space utilization of the battery pack and reduces the overall size and weight of the battery pack.

In order to achieve the above object, the present disclosure provides a battery pack, which comprises a base plate and at least one battery module. Each battery module comprises: a battery group including a plurality of batteries arranged in a Y direction; two end plates respectively positioned at two ends of the battery group in the Y direction; and two side plates respectively positioned at two ends of the battery group in an X direction. Each battery module is fixed to the base plate, and one of the side plates of each battery module faces the base plate.

The present disclosure has the following beneficial effects: in the battery pack according to the present disclosure, each battery module comprises the battery group, the two end plates and two side plates surrounding and clamping the battery group and each battery module is fixed to the base plate so that the battery pack is formed, the structure of the battery pack is simple and the assembling of the battery pack is convenient. Moreover, one of the side plates of each battery module faces the base plate, in other words, one of the side plates of each battery module and the base plate face each other, thus one of the side plates of each battery module lies on the base plate. Compared with the positive arrangement of the traditional battery module, the battery pack of the present disclosure greatly improves the space utilization of the battery pack and reduces the overall size and weight of the battery pack.

### BRIEF DESCRIPTION OF THE FIGURES

FIG. 1 is an exploded perspective view of an embodiment of a battery pack according to the present disclosure.

FIG. 2 is an assembled perspective view of FIG. 1.

FIG. 3 is an exploded view of a reinforcing assembly of FIG. 2.

FIG. 4 is an exploded view of a cooling assembly of FIG. 2.

FIG. 5 is a perspective view of a first fixing bracket of FIG. 2.

FIG. 6 is an exploded perspective view of another embodiment of the battery pack according to the present disclosure.

FIG. 7 is an assembled perspective view of FIG. 6.

FIG. 8 is an exploded view of a cooling assembly of FIG. 7.

FIG. 9 is a perspective view of a second fixing bracket of FIG. 7.

### REFERENCE NUMERALS ARE REPRESENTED AS FOLLOWS

1 base plate
2 battery module
21 end plate
211 through hole
22 side plate
3 first fixing bracket
31 first bottom plate
32 first side plate
33 first mounting plate
331 first penetrating hole
34 top reinforcing plate
35 side reinforcing plate
36 bottom reinforcing plate
4 fastener
5 reinforcing assembly
51 locking member
52 first buffering pad
53 second buffering pad
54 pressure bar
6 cooling assembly
61 cooling pipe
62 thermal conductive pad
7 second fixing bracket
71 second bottom plate
72 second mounting plate
721 second penetrating hole
73 supporting plate
74 side reinforcing plate
75 bottom reinforcing plate
X direction
Y direction
Z direction

### DETAILED DESCRIPTION

Hereinafter a battery pack according to the present disclosure will be described in detail in combination with the figures.

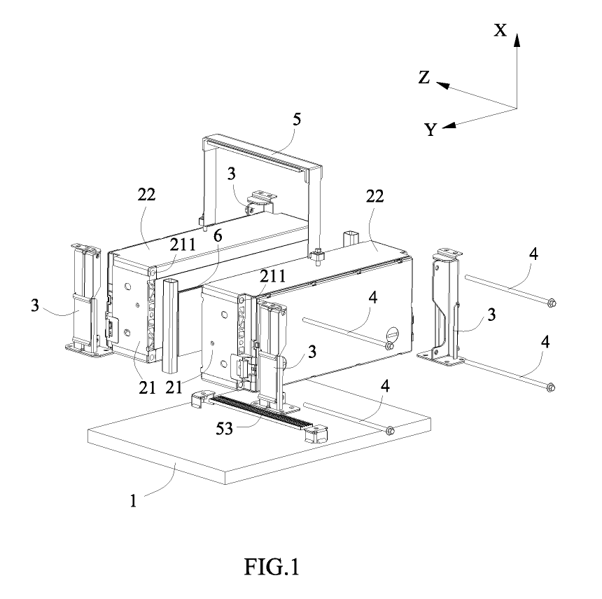

Referring to FIG. 1 to FIG. 9, a battery pack according to the present disclosure comprises a base plate 1 and at least one battery module 2. Each battery module 2 comprises: a battery group including a plurality of batteries arranged in a Y direction; two end plates 21 respectively positioned at two ends of the battery group in the Y direction; and two side plates 22 respectively positioned at two ends of the battery group in an X direction. Each battery module 2 is fixed to the base plate 1, and one of the side plates 22 of each battery module faces the base plate 1.

In the battery pack according to the present disclosure, each battery module 2 comprises the battery group and the two end plates 21 and two side plates 22 surrounding and clamping the battery group, and each battery module 2 is fixed to the base plate 1, so that the battery pack is formed, the structure of the battery pack is simple and the assembling of the battery pack is convenient. Moreover, one of the side plates 22 of each battery module 2 faces the base plate 1, in other words, one of the side plates 22 of each battery module 2 and the base plate 1 face each other, thus one of the side plates 22 of each battery module 2 lies on the base plate 1 (namely, a width direction of each battery module 2 is parallel to a thickness direction of the base plate 1). Compared with the positive arrangement of the traditional battery module 2 (namely, a height direction of each battery module 2 is parallel to the thickness direction of the base plate 1), the battery pack of the present disclosure greatly improves the space utilization of the battery pack and reduces the overall size and weight of the battery pack.

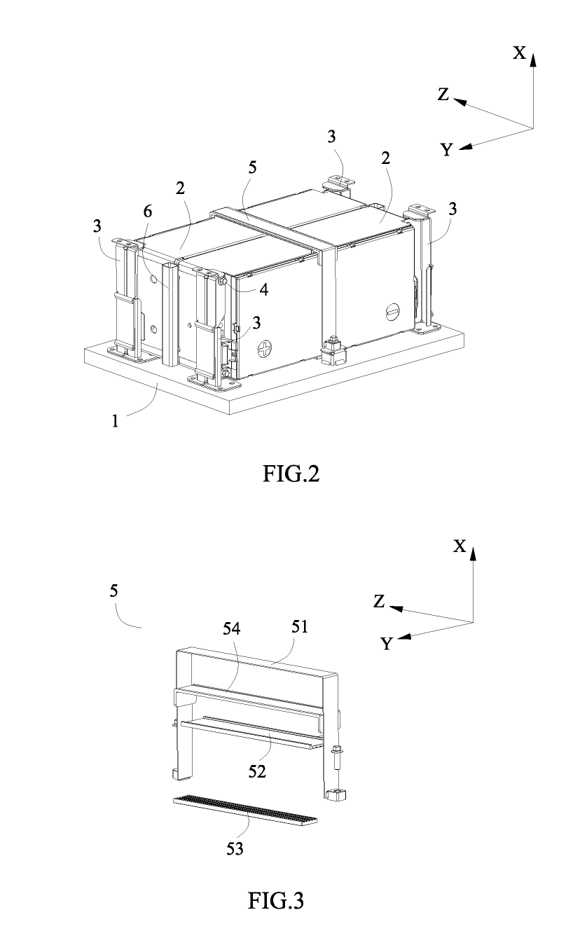

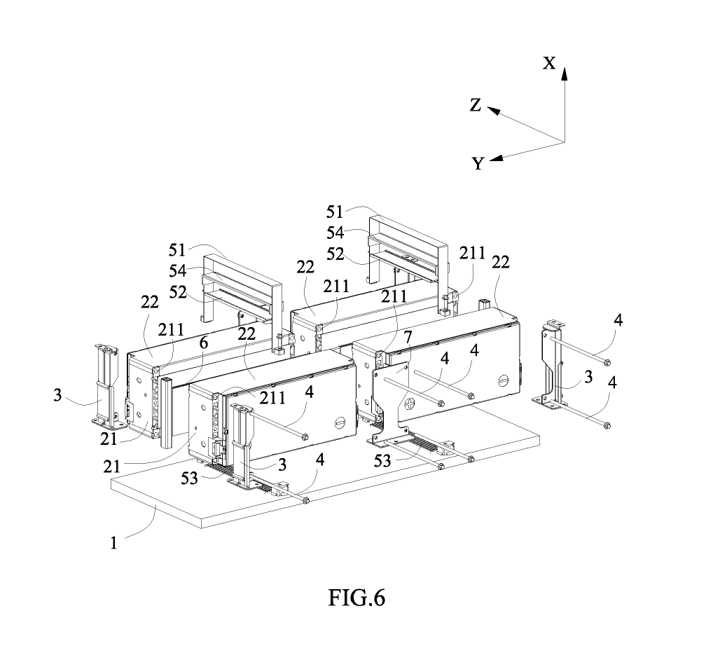

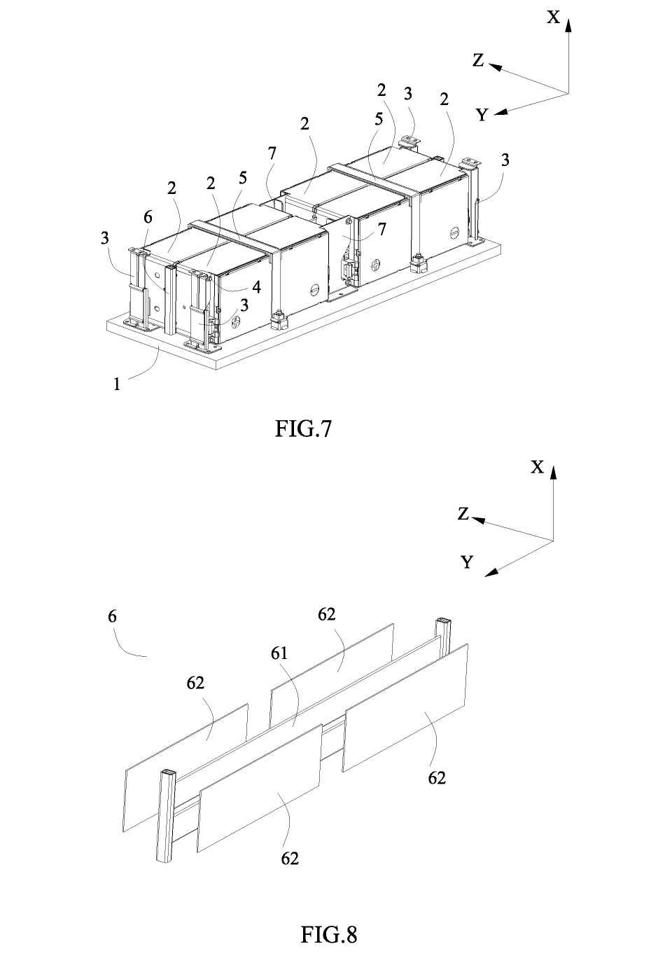

In the battery pack according to the present disclosure, the battery module 2 can be provided as one or multiple in number. When the battery module 2 is provided as multiple in number, referring to FIG. 1 and FIG. 2, the multiple battery modules 2 can be arranged side by side on the base plate 1 only in a Z direction. Referring to FIG. 6 and FIG. 7, the multiple battery modules 2 can be arranged side by side on the base plate 1 in the Z direction and the Y direction. Certainly, the multiple battery modules 2 also can be arranged side by side on the base plate 1 only in the Y direction. Here, the multiple battery modules 2 can be arranged in two or more layers in the X direction based on the number of the battery modules 2.

Referring to FIG. 1, FIG. 2, FIG. 6 and FIG. 7, in the battery pack according to the present disclosure, the battery pack may further comprise first fixing brackets 3 at least positioned at outermost sides of the battery pack in the Y direction, the first fixing brackets 3 are respectively provided to outer sides of the end plate 21 which are outermost in the Y direction of the battery pack, and the first fixing brackets 3 are securely connected to the base plate 1. So the movement of each battery module 2 which is outermost in the Y direction is limited.

Referring to FIG. 1 and FIG. 2, in an embodiment, each outer side of the end plates 21 of each battery module 2 is provided with the first fixed bracket 3. Referring to FIG. 6 and FIG. 7, in another embodiment, the battery module 2 is provided as multiple in number, and the multiple battery modules 2 are arranged side by side in the Y direction, only the outer side of the end plate 21 of each battery module 2 which is outermost in the Y direction of the battery pack is provided with the first fixing bracket 3. The battery pack may further comprise a second fixing bracket 7 positioned between the two adjacent end plates 21 of every two adjacent battery modules 2 in the Y direction and securely connected to the base plate 1.

Referring to FIG. 1, FIG. 2, FIG. 6 and FIG. 7, in the battery pack according to the present disclosure, each end of each the end plate 21 of each battery module 2 in the X direction is provided with a through hole 211 passing through each end plate 21 in the Z direction. The battery pack may further comprise: a plurality of fasteners 4 respectively inserted into the through holes 211 of the end plates 21 of the multiple battery modules 2 to lock each first fixing bracket 3 and the battery module 2 which is outermost in the Y direction of the battery pack and lock each second fixing bracket 7 and two battery modules 2 which are adjacent to each second fixing bracket 7.

Referring to FIG. 5, in the battery pack according to the present disclosure, each first fixing bracket 3 may comprise: a first bottom plate 31 securely connected to the base plate 1; a first mounting plate 33 provided uprightly to the first bottom plate 31 in the X direction and provided with a first penetrating hole 331 passing through the first mounting plate 33 in the Z direction. Here, the corresponding fastener 4 is inserted into the first penetrating hole 331 of the first fixing bracket 3 and the corresponding through hole 211 of the end plate 21 in order, thus makes the first fixing bracket 3 locked and connected to the corresponding battery module 2 to limit the movement of the corresponding battery module 2 in the Z direction. In addition, the first fixing bracket 3 may further comprise: a first side plate 32 provided uprightly to the first bottom plate 31 in the X direction; a top reinforcing plate 34 provided on a top side of the first mounting plate 33 and parallel to the first bottom plate 31; a side reinforcing plate 35 provided to an outer side of the first side plate 32 in the Z direction; and a bottom reinforcing plate 36 provided to a bottom side of the first bottom plate 31.

It should be noted that, the first mounting plate 33 provides a mounting position (that is the first penetrating hole 331) for the corresponding fastener 4 and ensures the mounting strength, the top reinforcing plate 34 and the bottom reinforcing plate 36 are used for reinforcing the strength of each first fixing bracket 3 and ensuring the mounting planeness of each first fixing bracket 3, and the side reinforcing plate 35 is used for reinforcing the strength of a weakjavascript:void(0); location of a lower part of the first mounting plate 33.

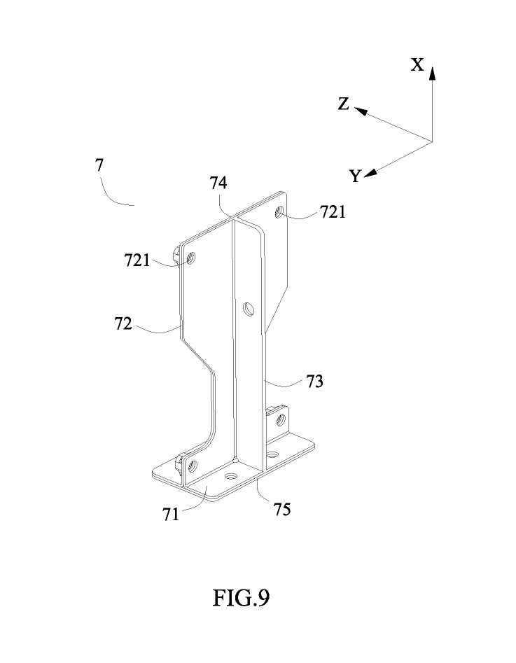

Referring to FIG. 9, in the battery pack according to the present disclosure, each second fixing bracket 7 may comprise: a second bottom plate 71 securely connected to the base plate 1; and a second mounting plate 72 provided uprightly to the second bottom plate 71 in the X direction and provided with a second penetrating hole 721 passing through the second mounting plate 72 in the Z direction. Here, the corresponding fastener 4 is inserted into the second penetrating hole 721 of the second fixing bracket 7 and the corresponding through hole 211 of the end plate 21 in order, thus makes the second fixing bracket 7 locked and connected to the corresponding battery module 2 to limit the movement of the corresponding battery module 2 in the Z direction. In addition, the second fixing bracket 7 may further comprise: a supporting plate 73 connected to the second bottom plate 71 and the second mounting plate 72 and simultaneously perpendicular to the second bottom plate 71 and the second mounting plate 72; a side reinforcing plate 74 provided to an outer side of the second mounting plate 72 in the Z direction; and a bottom reinforcing plate 75 provided to a bottom side of the second bottom plate 71.

It should be noted that, the second mounting plate 72 provides a mounting position (that is the second penetrating hole 721 for the corresponding fastener 4 and ensures the mounting strength, the side reinforcing plate 74 is used for reinforcing the strength of the second mounting plate 72, the bottom reinforcing plate 75 is used for reinforcing the strength of each second fixing bracket 7 and ensuring the mounting planeness of each second fixing bracket 7.

In the battery pack according to the present disclosure, each fastener 4 can be a long bolt, the first fixing bracket 3 is screwed with the corresponding fastener 4, and the second fixing bracket 7 is screwed with the corresponding fastener 4.

Referring to FIG. 1 to FIG. 3 and FIG. 6 and FIG. 7, in the battery pack according to the present disclosure, the battery module 2 is provided as multiple in number, the multiple battery modules 2 arranged side by side in at least one row on the base plate 1 in the Z direction, the battery pack may further comprise a reinforcing assembly 5 provided in a middle part of each row of the battery modules 2 and securely connected to the base plate 1 to limit movement of each battery module 2 in each row in the X direction.

Further referring to FIG. 3, each reinforcing assembly 5 may comprise: a locking member 51 encircling the battery modules 2 in each row and securely locked to the base plate 1; a first buffering pad 52 positioned between the locking member 51 and the battery modules 2 in each row; and a second buffering pad 53 positioned between the battery modules 2 in each row and the base plate 1, and the second buffering pad 53 is aligned with the first buffering pad 52 in the X direction, and the locking member 51 squeezes the first buffering pad 52 and the second buffering pad 53 (that is when and after the locking member 51 is locked to the base plate 1). Here, the first buffering pad 52 and the second buffering pad 53 can be made of rubber material, and play function of buffering when the battery module 2 is vibrated. In addition, each reinforcing assembly 5 may further comprise a pressure bar 54 positioned between the locking member 51 and the first buffering pad 52.

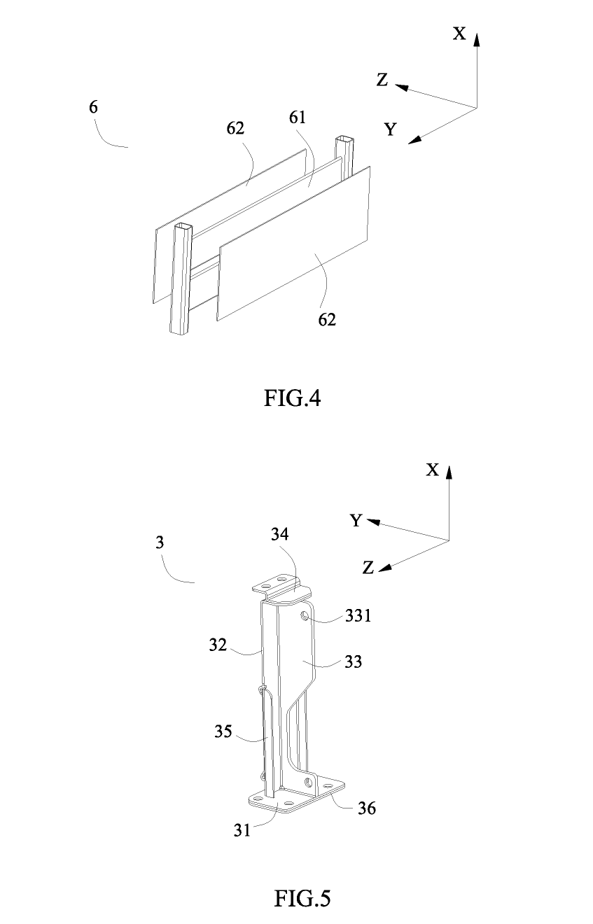

Referring to FIG. 1, FIG. 2, FIG. 4, FIG. 6 and FIG. 7, in the battery pack according to the present disclosure, the battery pack may further comprise a cooling assembly 6 provided between every two adjacent battery modules 2 in each row to cool every two adjacent battery module 2. Further referring to FIG. 4, the cooling assembly 6 may comprise a cooling pipe 61 provided between every two adjacent battery modules 2 in each row and cooling every two adjacent battery modules 2; and thermal conductive pads 62 respectively at two side of the cooling pipe 61 in the Z direction, at least one thermal conductive pad 62 is positioned between the cooling pipe 61 and each of every two adjacent battery modules 2.

Referring to FIG. 1 and FIG. 2, specifically, when multiple battery modules 2 are arranged side by side in the Z direction, each cooling assembly 6 is positioned between every two adjacent battery modules 2 arranged side by side in the Z direction. Referring to FIG. 6 and FIG. 7, when multiple battery modules 2 are arranged side by side in the Z direction and multiple battery modules 2 are also arranged side by side in the Y direction, each cooling assembly 6 extends in the Y direction to cool simultaneously all the battery modules 2 which are arranged in the Y direction and adjacent to each cooling assembly 6.

What is claimed:

1. A battery pack, comprising:
a base plate;
at least one battery module, each battery module comprising:
a battery group including a plurality of batteries arranged in a Y direction;
two end plates respectively positioned at two ends of the battery group in the Y direction; and
two side plates respectively positioned at two ends of the battery group in an X direction;
wherein
each battery module is fixed to the base plate, and one of the side plates of each battery module faces the base plate.

2. The battery pack according to claim 1, wherein
the battery pack further comprises first fixing brackets at least positioned at outermost sides of the battery pack in the Y direction, the first fixing brackets are respectively provided to outer sides of the end plates which are outermost in the Y direction of the battery pack, and the first fixing brackets are securely connected to the base plate.

3. The battery pack according to claim 2, wherein
each outer side of the end plates of each battery module is provided with the first fixed bracket.

4. The battery pack according to claim 2, wherein
the battery module is provided as multiple in number, and the multiple battery modules are arranged side by side in the Y direction;
the battery pack further comprises a second fixing bracket positioned between the two adjacent end plates of every two adjacent battery modules in the Y direction and securely connected to the base plate.

5. The battery pack according to claim 4, wherein
each end of each end plate of each battery module in the X direction is provided with a through hole passing through each end plate in a Z direction;
the battery pack further comprises a plurality of fasteners respectively inserted into the through holes of the end plates of the multiple battery modules to lock each first fixing bracket and the battery module which is outermost in the Y direction of the battery pack and lock each second fixing bracket and two battery modules which are adjacent to each second fixing bracket.

6. The battery pack according to claim 5, wherein each first fixing bracket comprises:
a first bottom plate securely connected to the base plate; and
a first mounting plate provided uprightly to the first bottom plate in the X direction and provided with a first penetrating hole passing through the first mounting plate in the Z direction.

7. The battery pack according to claim 5, wherein each second fixing bracket comprises:
a second bottom plate securely connected to the base plate; and
a second mounting plate provided uprightly to the second bottom plate in the X direction and provided with a second penetrating hole passing through the second mounting plate in the Z direction.

8. The battery pack according to claim 1, wherein
the battery module is provided as multiple in number, the multiple battery modules arranged side by side in at least one row on the base plate in a Z direction,
the battery pack further comprises:
a reinforcing assembly provided in a middle part of each row of the battery modules and securely connected to the base plate to limit movement of each battery module in each row in the X direction; and
a cooling assembly provided between every two adjacent battery modules in each row to cool every two adjacent battery modules.

9. The battery pack according to claim 8, wherein each reinforcing assembly comprises:
a locking member encircling the battery modules in each row and securely locked to the base plate;
a first buffering pad positioned between the locking member and the battery modules in each row; and
a second buffering pad positioned between the battery modules in each row and the base plate, the second buffering pad is aligned with the first buffering pad in the X direction, and the locking member squeezes the first buffering pad and the second buffering pad.

10. The battery pack according to claim 8, wherein each cooling assembly comprises:
a cooling pipe provided between every two adjacent battery modules in each row and cooling the every two adjacent battery modules in each row; and
thermal conductive pads respectively positioned at two side of the cooling pipe in the Z direction, at least one thermal conductive pad is positioned between the cooling pipe and each of every two adjacent battery modules.
